(19) United States
(12) Patent Application Publication
(10) Pub. No.: US 2010/0225545 A1
(43) Pub. Date: Sep. 9, 2010

(54) CAPACITIVE-FEED ANTENNA AND WIRELESS COMMUNICATION APPARATUS HAVING THE SAME

(75) Inventors: Masamichi TAMURA, Ishikawa-ken (JP); Satoru HIRANO, Ishikawa-ken (JP); Yuichi KUSHIHI, Ishikawa-ken (JP)

Correspondence Address: Studebaker & Brackett PC, One Fountain Square, 11911 Freedom Drive, Suite 750, Reston, VA, 20190, US

(73) Assignee: MURATA MANUFACTURING CO., LTD., Kyoto-fu (JP)

(21) Appl. No.: 12/779,118

(22) Filed: May 13, 2010

Related U.S. Application Data
(63) Continuation of application No. PCT/JP2008/067306, filed on Sep. 25, 2008.

(30) Foreign Application Priority Data
Nov. 13, 2007 (JP) 2007-294562

(51) Int. Cl. H01Q 9/04; H01Q 1/24; H01Q 1/38

(52) U.S. Cl. 343/702; 343/700 MS

(57) ABSTRACT

A dielectric substrate having a radiation electrode 3 and a feed electrode 4 formed thereon is formed such that a plurality of insulator layers 7a to 7e are stacked and combined. An open end 3K of the radiation electrode 3 and a capacitive coupling end 4Y of the feed electrode 4 are formed on a surface of the same insulator layer of the dielectric substrate 2. A floating electrode 5 is formed on a surface of an insulator layer on which the open end 3K of the radiation electrode 3 and the capacitive coupling end 4Y of the feed electrode 4 are not formed. The floating electrode 5 is arranged to commonly face both the open end 3K of the radiation electrode 3 and the capacitive coupling end 4Y of the feed electrode 4 in the stacking direction of the insulator layers 7a to 7e.

### CROSS REFERENCE TO RELATED APPLICATIONS

The present application is a continuation of International Application No. PCT/JP2008/067306, filed Sep. 25, 2008, which claims priority to Japanese Patent Application No. 2007-294562 filed Nov. 13, 2007, the entire contents of each of these applications being incorporated herein by reference in their entirety.

### BACKGROUND

1. Field of the Invention

The present invention relates to a capacitive-feed antenna provided with a capacitive-feed radiation electrode, and a wireless communication apparatus having the capacitive-feed antenna.

2. Description of the Related Art

FIG. 5 shows a schematic perspective view of an example structure of a capacitive-feed antenna, such as shown in Japanese Unexamined Patent Application Publication No. 2004-56506, for example. As shown, a capacitive-feed antenna 30 includes a dielectric substrate 31, a radiation electrode 32, a feed electrode 33, and a ground electrode 34. In the capacitive-feed antenna 30, the dielectric substrate has the shape of a rectangular parallelepiped. The radiation electrode 32 is formed, as shown in FIG. 5, on the dielectric substrate 31 extending from the lower edge of a right surface 31R upward and onto a top surface 31U of the dielectric substrate 31 until half way between the right end edge and the left end edge of the top surface 31U. A leading end of the radiation electrode 32 constitutes an open end. The radiation electrode 32 performs wireless communication (sending/receiving) of a signal. The electric length between the open end and the opposite end of the radiation electrode 32 is a length that allows the radiation electrode 32 to perform a resonance operation for a predetermined frequency band which has been set in advance for the wireless communication. This enables the radiation electrode 32 to perform wireless communication in the predetermined frequency band for the wireless communication.

One end of the feed electrode 33 is formed on a bottom surface 31D of the dielectric substrate 31. The feed electrode 33 is formed to extend from the lower surface 31D, through a left end surface 31L, to a position on the top surface 31U facing the open end of the radiation electrode 32 with a distance therebetween. The ground electrode 34 is formed on the bottom surface 31D of the dielectric substrate 31 so as to cover almost all the surface except an area in which the feed electrode 33 is formed. The ground electrode 34 is connected to the end of the radiation electrode 32 opposite the open end.

The capacitive-feed antenna 30, thus configured, is arranged at a predetermined mounting position of, for example, a circuit board of a wireless communication apparatus. Consequently, the feed electrode 33 is electrically connected to a wireless communication circuit (e.g., radio frequency circuit) 35 formed on the circuit board of the wireless communication apparatus. The ground electrode 34 is connected to the ground of the wireless communication apparatus. In this configuration, when a transmission signal is supplied from the wireless communication circuit 35 to the feed electrode 33, the transmission signal is transferred from the feed electrode 33 to the radiation electrode 32 through capacitive coupling between the feed electrode 33 and the radiation electrode 32. Consequently, the transmission signal is transmitted by excitation of the radiation electrode 32. When a wireless signal arrives and is received by excitation of the radiation electrode 32, the received signal is transferred through capacitive coupling between the feed electrode 33 and the radiation electrode 32 from the radiation electrode 32 to the feed electrode 33, and further to the wireless communication circuit 35 from the feed electrode 33.

The impedance matching between the radiation electrode 32 and the wireless communication circuit 35 is adjustable by adjusting the value of capacitance formed between the radiation electrode 32 and the feed electrode 33. Hence, in order to adjust the impedance between the radiation electrode 32 and the wireless communication circuit 35, larger capacitance may be required between the radiation electrode 32 and the wireless communication circuit 35.

According to the device described in Japanese Unexamined Patent Application Publication No. 2004-56506, it is difficult to change the longitudinal physical length of the radiation electrode 32, due to the design requirement for the above-described electric length. The capacitance can be increased, if the distance between the radiation electrode 32 and the feed electrode 33 is decreased. However, this will cause a manufacturing tolerance problem. In other words, increasing the capacitance between the radiation electrode 32 and the feed electrode 33 by narrowing the distance between the radiation electrode 32 and the feed electrode 33 is difficult due to a manufacturing tolerance problem.

Alternatively, the capacitance between the radiation electrode 32 and the feed electrode 33 can be increased by enlarging the respective electrode portions of the radiation electrode 32 and the feed electrode 33 facing each other. However, this will cause a problem in that the capacitive-feed antenna 30 becomes larger. In other words, there arises a problem in that the capacitive-feed antenna 30 becomes larger and, thus, is contrary to the reduction in the size of the capacitive-feed antenna 30 built in a wireless communication apparatus that is required in accordance with the recent trend in reduction in the size of the wireless communication apparatus.

### SUMMARY

Embodiments consistent with the claimed invention have been conceived to solve the problem described above. According to an exemplary embodiment, a capacitive-feed antenna includes a substrate in which a plurality of insulator layers are stacked and combined; a radiation electrode whose open end is formed on a surface of one of the plurality of the insulator layers; and a feed electrode for feeding the radiation electrode, the feed electrode including a capacitive coupling end having capacitive coupling with the open end of the radiation electrode, the capacitive coupling end being formed on the surface of the insulator layer of the substrate with a distance from the open end of the radiation electrode.

A floating electrode is arranged on a surface of an insulator layer of the substrate on which the open end of the radiation electrode and the capacitive coupling end of the feed electrode are not formed. The floating electrode is made to commonly face both the open end of the radiation electrode and the capacitive coupling end of the feed electrode in the stacking direction of the insulator layers so as to form capacitance between itself and the open end of the radiation electrode and capacitance between itself and the capacitive coupling end of the feed electrode. Capacitance formed between the open end of the radiation electrode and the capacitive coupling end of the feed electrode is enhanced by the floating electrode.

A wireless communication apparatus according to another exemplary embodiment consistent with the claimed invention is provided with the capacitive-feed antenna having the configuration which is characteristic of the present invention.

According to the embodiments consistent with the claimed invention, the substrate is formed such that a plurality of insulator layers are stacked and combined. The floating electrode is formed to commonly face both the open end of the radiation electrode and the capacitive coupling end of the feed electrode in the stacking direction of the insulator layers of the substrate. The floating electrode forms capacitance between itself and the open end of the radiation electrode and capacitance between itself and the capacitive coupling end of the feed electrode. Hence, a state is realized in which between the open end of the radiation electrode and the capacitive coupling end of the feed electrode, capacitance is formed between the open end of the radiation electrode and the floating electrode, and capacitance is formed between the capacitive coupling end of the feed electrode and the floating electrode, in addition to capacitance formed between the open end of the radiation electrode and the capacitive coupling end of the feed electrode. Consequently, the present embodiment allows capacitance between the open end of the radiation electrode and the capacitive coupling end of the feed electrode to be easily increased without changing the forming positions or shapes of the open end of the radiation electrode and the capacitive coupling end of the feed electrode.

Further, the restrictions on the design of the floating electrode are not strict (i.e., high degree of freedom of design). Hence, it is easy to adjust the amount of the capacitance between the open end of the radiation electrode and the capacitive coupling end of the feed electrode so as to satisfy requirements, since the size of the floating electrode can be appropriately adjusted, for example. In other words, according to the present embodiment, the capacitance between the open end of the radiation electrode and the capacitive coupling end of the feed electrode can be made sufficiently large to satisfy requirements with high accuracy, while preventing an increase in the size of the capacitive-feed antenna.

Other features, elements, characteristics and advantages of the embodiments consistent with the claimed invention will become more apparent from the following detailed description of preferred embodiments of the present invention with reference to the attached drawings.

### BRIEF DESCRIPTION OF DRAWINGS

FIG. 1a is an explanatory illustration of a capacitive-feed antenna of an exemplary first embodiment.

FIG. 1b is an explanatory exploded view of FIG. 1a.

FIG. 2a is an explanatory exploded view of a capacitive-feed antenna according to an exemplary second embodiment.

FIG. 2b is an explanatory plan view of FIG. 2a.

FIG. 3a is an explanatory exploded view of a capacitive-feed antenna according to an exemplary third embodiment.

FIG. 3b is an explanatory plan view of FIG. 3a.

FIG. 4a is an illustration for explaining another exemplary embodiment.

FIG. 4b is an illustration for explaining still another exemplary embodiment.

FIG. 5 is an explanatory perspective view of an example of a conventional capacitive-feed antenna.

### DETAILED DESCRIPTION

Hereinafter, with reference to various embodiments consistent with the claimed invention, the features of the embodiments will be described in more detail.

A first exemplary embodiment will be described with reference to the drawings.

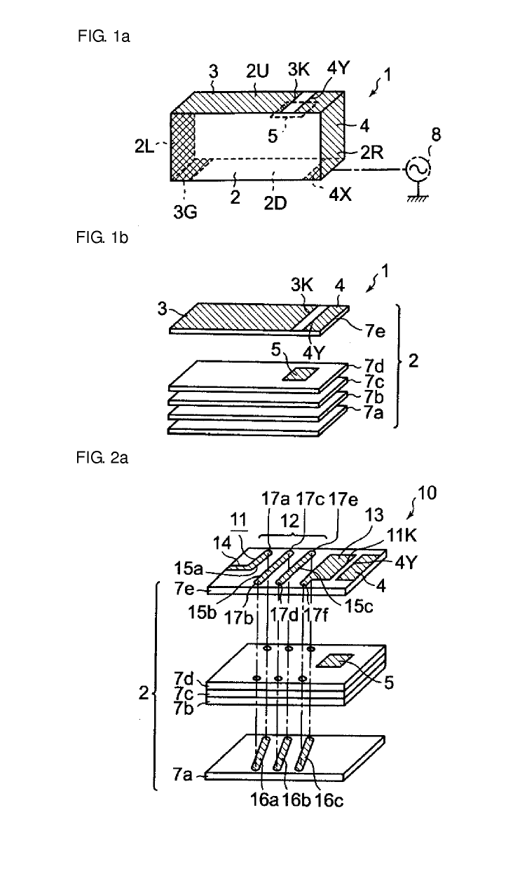

FIG. 1a shows a schematic perspective view of a capacitive-feed antenna of a first exemplary embodiment. FIG. 1b shows a schematic exploded view of the capacitive-feed antenna of FIG. 1a. The capacitive-feed antenna 1 of the first embodiment includes a dielectric substrate 2 as a substrate, a radiation electrode 3, a feed electrode 4, and a floating electrode 5. The dielectric substrate 2 has the shape of a rectangular parallelepiped. The dielectric substrate 2 is formed by stacking and combining a plurality (e.g., five layers in the example shown in FIG. 1b) of insulator layers 7a to 7e.

The radiation electrode 3 is formed on the dielectric substrate 2 in such manner as to extend from a bottom surface 2D, through a side surface 2L, to a top surface 2U (i.e., the upper surface of the uppermost layer 7e) of the dielectric substrate 2. The radiation electrode 3 is formed by applying, for example, copper electrode paste. A leading end 3K of the radiation electrode 3 constitutes an open end. An end 3G opposite the open end 3K constitutes a ground end. The electric length between the ground end 3G and the open end 3K of the radiation electrode 3 has been set on the basis of an electric length that allows for a resonance operation in a predetermined frequency band for the wireless communication.

The feed electrode 4 is formed to extend from the bottom surface 2D, through a side surface 2R, to the top surface 2U (upper surface of the uppermost layer 7e). Note that in the respective exploded views, such as FIG. 1b, only a portion of the feed electrode 4 formed on the top surface of an insulator layer (7e in the example shown in FIG. 1b) is illustrated. A leading end 4Y of the feed electrode 4 is arranged so as to face the open end 3K of the radiation electrode 3 with a distance therebetween. The leading end 4Y of the feed electrode 4 constitutes a capacitive coupling end that has capacitive coupling with the open end 3K of the radiation electrode 3. An end 4X of the feed electrode 4 opposite the capacitive coupling end 4Y constitutes a circuit connection end electrically connected to a wireless communication circuit 8 of a wireless communication apparatus.

The floating electrode 5 is formed to face both the open end 3K of the radiation electrode 3 and the capacitive coupling end 4Y of the feed electrode 4 in the stacking direction of the insulator layers 7a to 7e. The floating electrode 5 is formed to generate capacitance between itself and both the open end 3K of the radiation electrode 3 and the capacitive coupling end 4Y of the feed electrode 4. The floating electrode 5 is formed on the upper surface (i.e., inside of the dielectric substrate 2) of the insulator layer 7d, where the open end 3K of the radiation electrode 3 and the capacitive coupling end 4Y of the feed electrode 4 are not formed.

In the capacitive-feed antenna 1 of the first embodiment, by means of providing the floating electrode 5, capacitance is formed between the open end 3K of the radiation electrode 3 and the capacitive coupling end 4Y of the feed electrode 4 as described hereinafter.

The capacitive-feed antenna 1 is in a configuration wherein, in addition to capacitance C₃₋₄ directly formed between the open end 3K of the radiation electrode 3 and the capacitive coupling end 4Y of the feed electrode 4, a circuit is connected in parallel consisting of a series circuit made up of capacitance C₃₋₅ formed between the open end 3K of the radiation electrode 3 and the floating electrode 5 and capacitance C₄₋₅ formed between the capacitive coupling end 4Y of the feed electrode 4 and the floating electrode 5. Accordingly, when a certain capacitance value is required to obtain favorable impedance matching between the radiation electrode 3 and the wireless communication circuit 8, the floating electrode 5 is formed to have a particular size and characteristics which cause the capacitance of a required value to be formed between itself and the open end 3K of the radiation electrode 3 and the capacitive coupling end 4Y of the feed electrode 4. Specifically, the size and the characteristics are set taking into account the value of the capacitance C₃₋₄, the conductivity of the dielectric substrate 2, and the width of the insulator layer 7e (i.e., the distance between the floating electrode 5 and the open end 3K of the radiation electrode 3 and the distance between the floating electrode 5 and the capacitive coupling end 4Y of the feed electrode 4) and the like.

Hereinafter, a second embodiment is described. In the description of the second embodiment, configuration components that are the same as those of the first embodiment are denoted by the same reference numerals and duplicate descriptions of the common components are omitted.

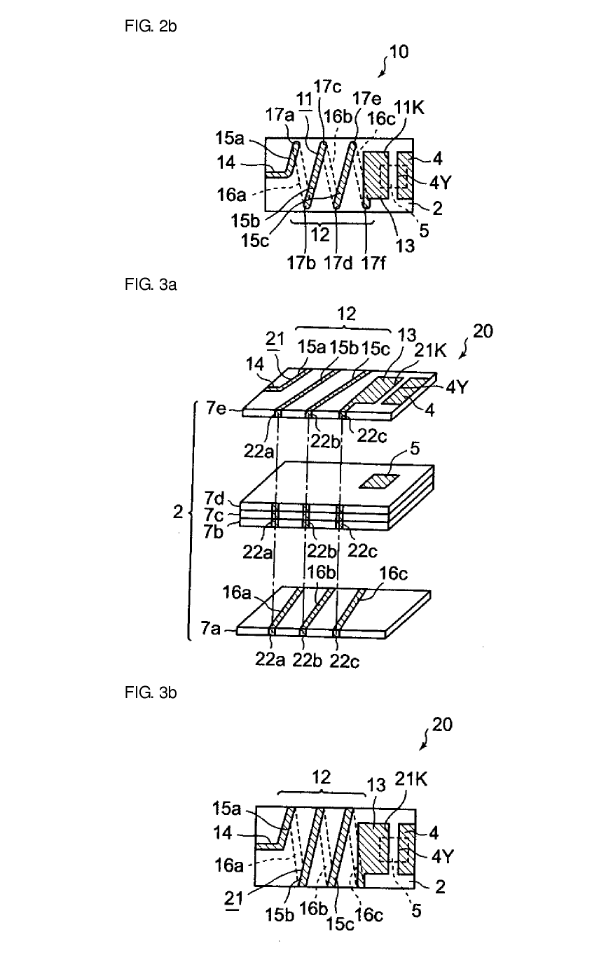

FIG. 2a shows an exploded schematic view of a capacitive-feed antenna according to the second embodiment. FIG. 2b shows a plan view of the capacitive-feed antenna shown in FIG. 2a seen from above. A radiation electrode 11 of the capacitive-feed antenna 10 includes a helical portion 12, a plane-shaped open end portion 13 between the helical portion 12 and an open end 11K, and a ground connection side portion 14 between the helical portion 12 and a ground end.

The helical portion 12 includes a plurality of electrode elements 15a to 15c arranged on the upper surface of the insulator layer 7e of a dielectric substrate 2 and a plurality of electrode elements 16a to 16c arranged on the upper surface of the insulator layer 7a, which is different from the insulator layer 7e, and via holes 17a to 17f.

The via holes 17a to 17f connect the electrode elements 15a to 15c to the respective predetermined counterparts of the electrode elements 16a to 16c. In the helical portion 12, all the line-shaped electrode elements 15a to 15c and electrode elements 16a to 16c are electrically connected in sequence by the via holes 17a to 17f so as to form a continuous helical current path. The end of the ground end side helical portion 12 is continuously connected to the ground connection side portion 14.

The ground connection side portion 14 is formed to extend from the continuous connection portion of the helical portion 12 onto and down along the left end surface of the dielectric substrate 2 shown in FIGS. 2a and 2b, and then extend further onto the bottom surface. The end of the ground connection side portion 14, which is formed on the bottom surface, constitutes a ground end.

The open-end-side end of the helical portion 12 is continuously connected to the open end portion 13. The open end portion 13 is formed on the upper surface of the insulator layer 7e and has an end constituting the open end 11K of the radiation electrode 11. A capacitive coupling end 4Y of the feed electrode 4 is formed on the upper surface of the insulator layer 7e at a position facing the open end 11K of the radiation electrode 11 with a distance therebetween.

Similarly to the first embodiment, the second embodiment has a floating electrode 5. The floating electrode 5, formed on the upper surface of the insulator layer 7d, forms capacitance between itself and both of the open end 11K of the radiation electrode 11 and the capacitive coupling end 4Y of the feed electrode 4.

In the second embodiment, by providing a configuration in which the radiation electrode 11 has the helical portion 12, the electric length of the radiation electrode 11 can be increased without causing the dielectric substrate 2 to be enlarged. In other words, since the size of the dielectric substrate 2 required for forming the radiation electrode 11 having a predetermined electrical length becomes small, a reduction in the size of the capacitive-feed antenna 10 can be realized.

Hereinafter, a third embodiment is described. In the description of the third embodiment, configuration components that are the same as those of the first or second embodiment are denoted by the same reference numerals and duplicate descriptions of the common components are omitted.

FIG. 3a shows an exploded schematic view of a capacitive-feed antenna according to the third embodiment. FIG. 3b shows a plan view of the capacitive-feed antenna shown in FIG. 3a seen from above. A radiation electrode 21 of the capacitive-feed antenna 20 includes a helical portion 12 similarly to the radiation electrode 11 of the second embodiment. However, in the third embodiment, via holes for electrically connecting electrode elements 15a to 15c and the respective predetermined counterparts of electrode elements 16a to 16c making up the helical portion 12 are not provided.

In the third embodiment, instead of the via holes, a plurality of side electrodes 22a to 22c are provided on the surface of the front side of the dielectric substrate 2 shown in FIG. 3a, and a plurality of side electrodes (not shown) are provided on the surface of the back side of the dielectric substrate 2. These side electrodes are formed using, for example, the Dip method in which copper paste or the like is applied. All the line-shaped electrode elements 15a to 15c and 16a to 16c are connected in sequence by the side electrodes, whereby a continuous helical current path is formed.

Portions of the configuration of the capacitive-feed antenna 20 in the third embodiment other than those described above are the same as those of the second embodiment, and the floating electrode 5 capable of forming capacitance between itself and both of an open end 21k of the radiation electrode 21 and the capacitive coupling end 4Y of the feed electrode 4 is formed on the upper layer of an insulator layer 7d also in the third embodiment.

Hereinafter, a fourth embodiment is described. The fourth embodiment relates to a wireless communication apparatus. The wireless communication apparatus of the fourth embodiment is characterized by being provided with the capacitive-feed antenna 1 of the first embodiment, the capacitive-feed antenna 10 of the second embodiment, or the capacitive-feed antenna 20 of the third embodiment. There are various configurations for a wireless communication apparatus. The wireless communication apparatus of the fourth embodiment may have any of the various configurations except for the portion described above, which is characteristic of the invention, and the description thereof is omitted.

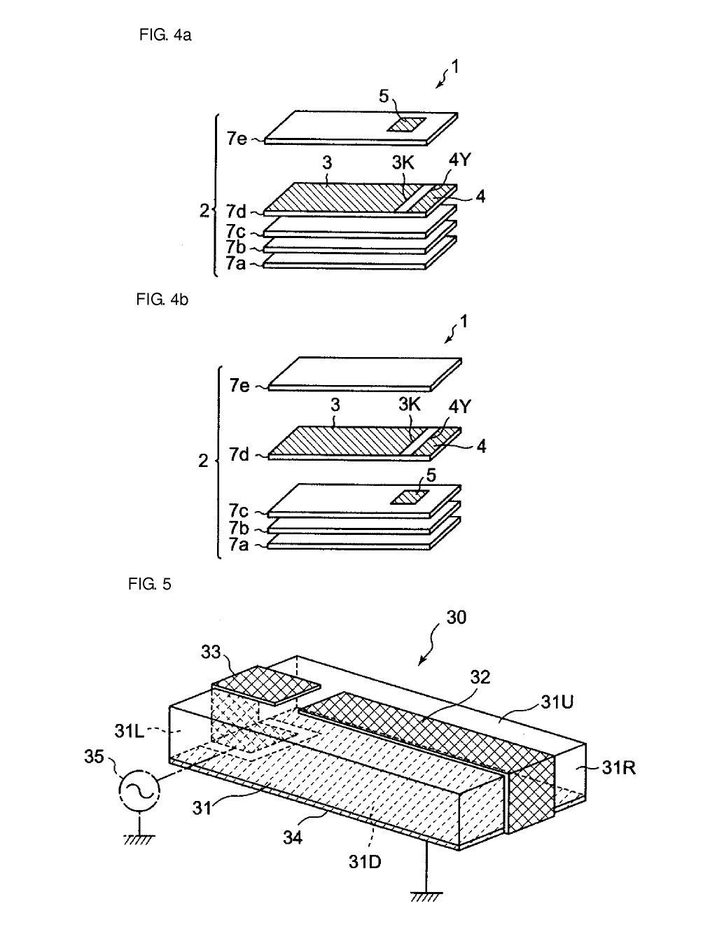

The present invention is not limited to the structures described in the first to fourth embodiments, and may have various structures. For instance, in the first to fourth embodiments, the respective open ends 3K, 11K, and 21K of the radiation electrodes 3, 11, and 21, and the capacitive coupling end 4Y of the feed electrode 4 are formed on the upper layer of the insulator layer 7e of the dielectric substrate 2. However, as shown in, for example, FIGS. 4a and 4b, the respective open ends 3K, 11K, and 21K of the radiation electrodes 3, 11, and 21, and the capacitive coupling end 4Y of the feed electrode 4 may be formed on the upper layer of an insulator layer (for example, the insulator layer 7d in the examples shown in FIGS. 4a and 4b) other than the insulator layer 7e of the dielectric substrate 2.

Further, the position at which the floating electrode 5 is formed is determined in association with the positions at which the respective open ends 3K, 11K, and 21K of the radiation electrodes 3, 11, and 21, and the capacitive coupling end 4Y of the feed electrode 4 are formed. In other words, the position at which the floating electrode 5 is formed is not limited to the upper surface of the insulator layer 7d as shown in the first to fourth embodiments, and it is only required that the floating electrode 5 be formed on an insulator layer on which the respective open ends 3K, 11K, and 21K of the radiation electrodes 3, 11, and 21, and the capacitive coupling end 4Y of the feed electrode 4 are not formed. For example, the floating electrode 5 may be formed on the upper surface of the insulator layer 7e (that is the top surface of the dielectric substrate 2), as shown in FIG. 4a. Alternatively, the floating electrode 5 may be formed on the upper surface of the insulator layer 7c as shown in FIG. 4b.

Further, in the first to fourth embodiments, the dielectric substrate 2 is made up of five layers, i.e., the insulator layers 7a to 7e. However, the number of layers making up the dielectric substrate 2 is not limited to five as long as it is more than one. The number of layers making up the dielectric substrate is appropriately determined considering, for example, the electric length required for the radiation electrodes 3, 11, and 21, the manufacturing method of the dielectric substrate 2, a predetermined width of the dielectric substrate 2, and the like.

In the second and third embodiments, the line-shaped electrode elements 15a to 15c making up the helical portion 12 are formed on the insulator layer 7e, and the electrode elements 16a to 16c are formed on the insulator layer 7a. However, the insulator layers on which the electrode elements 15a to 15c and the electrode elements 16a to 16c are formed are not limited to those as long as the electrode elements 15a to 15c are formed on an insulator layer different from an insulator layer on which the electrode elements 16a to 16c are formed. The number of winding turns of the helical portion 12 of the radiation electrodes 11 and 21 is three. However, the number of winding turns of the helical portion 12 is appropriately set on the basis of a predetermined electric length of the radiation electrode 11 or 12, and is not limited to three. The helical portion 12 may have, rather than an overall uniform winding, a non-uniform winding which is partly dense and partly sparse. Thus, the helical portion 12 may have a structure not limited to those shown in FIGS. 2 and 3.

By providing a specific structure, an antenna is realized which allows the capacitance between a radiation electrode and a feed electrode to be easily increased while preventing an increase in size. Hence, the embodiments consistent with the claimed invention are applicable to wireless communication apparatuses such as mobile phones and mobile terminals.

While preferred embodiments have been described above, it is to be understood that variations and modifications will be apparent to those skilled in the art without departing from the scope and spirit of the appended claims. The scope of the embodiments, therefore, is to be determined solely by the following claims.

What is claimed is:

1. A capacitive-feed antenna, comprising:
a substrate in which a plurality of insulator layers are stacked and combined;
a radiation electrode including an open end formed on a surface of one of the plurality of the insulator layers; and
a feed electrode to feed the radiation electrode, the feed electrode including a capacitive coupling end having capacitive coupling with the open end of the radiation electrode, the capacitive coupling end being formed on the surface of the insulator layer of the substrate with a distance from the open end of the radiation electrode,
wherein a floating electrode is arranged on a surface of an insulator layer of the substrate on which the open end of the radiation electrode and the capacitive coupling end of the feed electrode are not formed,
wherein the floating electrode is positioned to commonly face both the open end of the radiation electrode and the capacitive coupling end of the feed electrode in the stacking direction of the insulator layers to form capacitance between the floating electrode and the open end of the radiation electrode and capacitance between the floating electrode and the capacitive coupling end of the feed electrode, and
wherein capacitance formed between the open end of the radiation electrode and the capacitive coupling end of the feed electrode is enhanced by the floating electrode.

2. The capacitive-feed antenna according to claim 1,
wherein the radiation electrode includes a plurality of line-shaped electrode elements formed on the surfaces of the plurality of the insulator layers with distances therebetween, and a plurality of via holes each electrically connecting a predetermined pair of the line-shaped electrode elements formed on different insulator layers, and
wherein all the line-shaped electrode elements are electrically connected in sequence by the via holes to form a helical current path.

3. The capacitive-feed antenna according to claim 1,
wherein the radiation electrode includes a plurality of line-shaped electrode elements formed on the surfaces of the plurality of the insulator layers with distances therebetween, and a plurality of side electrodes formed on sides of the substrate, each of the plurality of side electrodes electrically connecting a predetermined pair of the line-shaped electrode elements formed on different insulator layers, and
wherein all the line-shaped electrode elements are electrically connected in sequence by the side electrodes to form a helical current path.

4. A wireless communication apparatus, comprising:
a capacitive-feed antenna, including:
a substrate in which a plurality of insulator layers are stacked and combined;
a radiation electrode including an open end formed on a surface of one of the plurality of the insulator layers; and
a feed electrode to feed the radiation electrode, the feed electrode including a capacitive coupling end having capacitive coupling with the open end of the radiation electrode, the capacitive coupling end being formed on the surface of the insulator layer of the substrate with a distance from the open end of the radiation electrode,
wherein a floating electrode is arranged on a surface of an insulator layer of the substrate on which the open end of the radiation electrode and the capacitive coupling end of the feed electrode are not formed,
wherein the floating electrode is positioned to commonly face both the open end of the radiation electrode and the capacitive coupling end of the feed electrode in the stacking direction of the insulator layers to form capacitance between the floating electrode and the open end of the radiation electrode and capacitance between floating electrode and the capacitive coupling end of the feed electrode, and
wherein capacitance formed between the open end of the radiation electrode and the capacitive coupling end of the feed electrode is enhanced by the floating electrode.

5. The wireless communication apparatus according to claim 4, wherein the radiation electrode includes a plurality of line-shaped electrode elements formed on the surfaces of the plurality of the insulator layers with distances therebetween, and a plurality of via holes each electrically connecting a predetermined pair of the line-shaped electrode elements formed on different insulator layers, and
wherein all the line-shaped electrode elements are electrically connected in sequence by the via holes to form a helical current path.

6. The wireless communication apparatus according to claim 4, wherein the radiation electrode includes a plurality of line-shaped electrode elements formed on the surfaces of the plurality of the insulator layers with distances therebetween, and a plurality of side electrodes formed on sides of the substrate, each of the plurality of the side electrodes electrically connecting a predetermined pair of the line-shaped electrode elements formed on different insulator layers, and
wherein all the line-shaped electrode elements are electrically connected in sequence by the side electrodes to form a helical current path.
